(19) United States
(12) Patent Application Publication
(10) Pub. No.: US 2009/0263679 A1
(43) Pub. Date: Oct. 22, 2009

(54) SHUTDOWN OPERATIONS FOR AN UNSEALED CATHODE FUEL CELL SYSTEM

(75) Inventors: Gary M. Robb, Honeoye Falls, NY (US); Hubert A. Gasteiger, Livorno (IT); Balasubramanian Lakshmanan, Pittsford, NY (US); Paul Taichiang Yu, Pittsford, NY (US); Steven G. Goebel, Victor, NY (US); Frederick T. Wagner, Fairport, NY (US)

Correspondence Address: GENERAL MOTORS COMPANY;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 12/103,939

(22) Filed: Apr. 16, 2008

(51) Int. Cl. H01M 8/04

(52) U.S. Cl. 429/13; 429/12

(57) ABSTRACT

Processes to shut down a fuel cell system are described. In one implementation (300), a load (215) is cyclically engaged and disengaged across a fuel cell stack (205) so as to deplete the fuel available to the system's fuel cells (205). Voltage and/or current thresholds may be used to determine when to engage and disengage the load (215) and when to terminate the shutdown operation. In another implementation (500), a variable load (405) is engaged and adjusted so as to deplete the fuel available to the system's fuel cells (205). As before, voltage and/or current thresholds may be used to determine when to adjust the load (405) and when to terminate the shutdown process. In still another implementation, a load (215 or 405) may be periodically engaged and disengaged during some portion of the shutdown process and engaged but adjusted during other portions of the shutdown process.

### FIELD OF THE INVENTION

The present invention relates a system and method for operating a fuel cell system and, more particularly, to a system and method for controlling fuel cell system shut-down operations.

### BACKGROUND

Fuel cells are electrochemical devices that convert chemical energy in fuels into electrical energy directly. In a typical operating cell, fuel is fed continuously to the anode (the negative electrode) and an oxidant is fed continuously to the cathode (positive electrode). Electrochemical reactions take place at the electrodes (i.e., the anode and cathode) to produce an ionic current through an electrolyte separating the electrodes, while driving a complementary electric current through a load to perform work (e.g., drive an electric motor or power a light). Though fuel cells could, in principle, utilize any number of fuels and oxidants, most fuel cells under development today use gaseous hydrogen as the anode reactant (aka, fuel) and gaseous oxygen, in the form of air, as the cathode reactant (aka, oxidant).

To obtain the necessary voltage and current needed for an application, individual fuel cells may be electrically coupled to form a “stack,” where the stack acts as a single element that delivers power to a load. The phrase “balance of plant” refers to those components that provide feedstream supply and conditioning, thermal management, electric power conditioning and other ancillary and interface functions. Together, fuel cell stacks and the balance of plant make up a fuel cell system.

Referring to FIG. 1A, fuel cell 100 (shown in a top-down view) is configured to include anode inlet 105, anode outlet 110, cathode inlet 115, cathode outlet 120, coolant inlet 125 and coolant outlet 130. Referring to FIG. 1B, as noted above fuel cells (e.g., fuel cell 100) may be stacked to create fuel cell stack 135, wherein each cell's anode, cathode and coolant passages are aligned.

One operational issue unique to fuel cell systems concerns system start-up and shut-down operations. Unlike internal combustion power plants, fuel cell electrodes may be damaged if exposed to improper gases and/or gas mixtures. For example, an anode's exposure to air can be very damaging to the cell if not done properly. Similarly, shut-down operations that generate mixtures of gasses (e.g., hydrogen-air solutions) may detrimentally affect the fuel cell system during subsequent start-up operations.

### SUMMARY

In general, the invention provides methods to shutdown a fuel cell system. A method in accordance with one embodiment includes halting the flow of fuel and, thereafter, initiating the flow of an inert gas (e.g., nitrogen) to the anodes of a fuel cell stack while maintaining the flow of oxidizer to the cathodes. A load is then cyclically engaged and disengaged across the fuel cell stack so as to deplete the fuel available to the system's fuel cells. Voltage and/or current thresholds may be used to determine when to engage and disengage the load and when to terminate the shutdown operation. Once the fuel cells are substantially depleted of fuel, an oxidizer fluid may be flowed across both the anode and cathodes with the load engaged until a second voltage and/or current threshold is met. The oxidizer fluid flow may then be halted and the load disengaged. In another embodiment, a variable load is engaged and adjusted so as to deplete the fuel available to the system's fuel cells. As noted above, voltage and/or current thresholds may be used to determine when to adjust the load and when to terminate the shutdown process. In still another implementation, a load may be periodically engaged and disengaged during some portion of the shutdown process and engaged but adjusted during other portions of the shutdown process.

Methods in accordance with the invention may be performed by a programmable control device executing instructions organized into one or more program modules. Programmable control devices comprise dedicated hardware control devices as well as general purpose processing systems. Instructions for implementing any method in accordance with the invention may be tangibly embodied in any suitable storage device.

### BRIEF DESCRIPTION OF THE DRAWINGS

Figure A shows the layout of a single fuel cell (1A) and fuel cell stack (1B) in accordance with conventional prior art fuel cell technology.

FIG. 2 shows a fuel cell system in accordance with one embodiment of the invention.

FIG. 3 shows a shutdown process in accordance with one embodiment of the invention.

FIG. 4 shows a fuel cell system in accordance with another embodiment of the invention.

FIG. 5 shows a shutdown process in accordance with another embodiment of the invention.

### DETAILED DESCRIPTION

The following description is presented to enable any person skilled in the art to make and use the invention as claimed and is provided in the context of the particular examples discussed below, variations of which will be readily apparent to those skilled in the art. More specifically, illustrative embodiments of the invention are described in terms of fuel cells that use gaseous hydrogen (H₂) as a fuel, oxygen (O₂) as an oxidant in the form of air (a mixture of O₂ and nitrogen, N₂) and proton exchange or polymer electrolyte membrane (“PEM”) electrode assemblies. The claims appended hereto, however, are not intended to be limited by the disclosed embodiments, but are to be accorded their widest scope consistent with the principles and features disclosed herein.

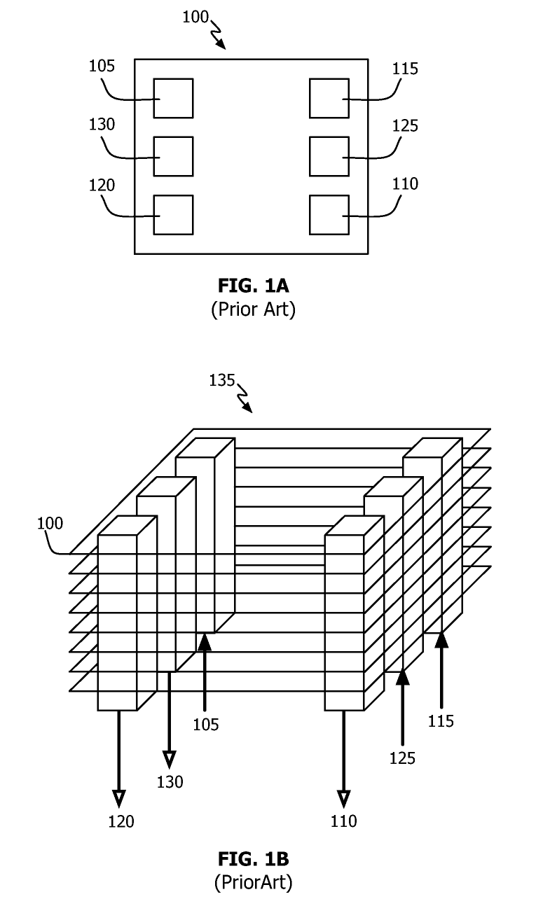

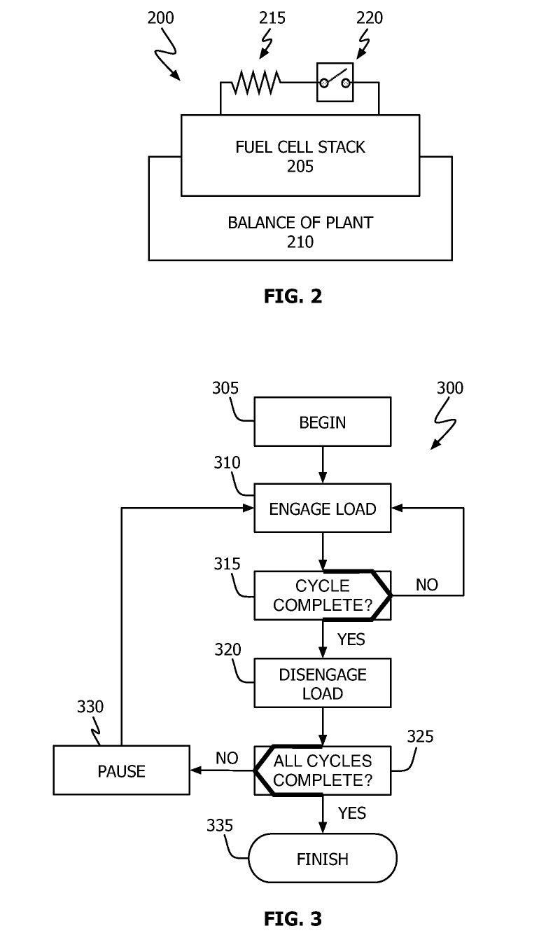

Referring to FIG. 2, in one embodiment of the invention fuel cell system 200 includes fuel cell stack 205, balance of plant 210, load 215 and switch 220. Fuel cell stack 205 includes a plurality of fuel cells, aligned as illustrated in FIG. 1B, with unsealed anodes and cathodes. As used herein, the term “unsealed” means that the designated element (e.g., anode) cannot hold a vacuum and is, when not operating, at substantially ambient pressure. As discussed in more detail below, in one embodiment, switch 220 is periodically cycled (i.e., closed and opened) to permit substantially all of the fuel present at, and in, the stack's anodes to be consumed in a safe, convenient and relatively rapid manner.

Referring to FIG. 3, in one embodiment shutdown operation 300 begins by terminating H₂ flow and, thereafter, initiating the flow of N₂ or some other inert gas across the anode (block 305). In one embodiment, a single anode's volume of nitrogen is used in this manner. In another embodiment, nitrogen flow is maintained for the process' entire duration. In yet another embodiment, no nitrogen purge is used. The general purpose of using nitrogen in this way is to remove or purge much of the fuel present at the anode although, it will be recognized, relatively large amounts of H₂ may remain absorbed in the electrode's catalyst. In general, if nitrogen is available, the minimum amount of nitrogen used in this manner would be one anode's volume, while the maximum nitrogen flow would be continued for the entire duration of the hydrogen consumption. Following initiation of the N₂ purge and in light of the continued O₂/air flow across the cathode, switch 220 is closed to engage load 215 (block 310). In practice, load 215 may be engaged before, simultaneously with or following the initiation of N₂ purge operations.

It will be recognized that balance of plant 210 includes fuel cell stack sensors such as, for example, voltage and/or current sensors for monitoring the activity of each, most or some fuel cells in fuel cell stack 205. These sensors may be used in accordance with the invention to determine when each discharge cycle (block 315) is complete and when all discharge cycles are complete (block 325).

Generally speaking, with load 215 engaged the voltage across each fuel cell will decrease as fuel at and within the cell's anode is consumed. For those implementations which monitor cell voltages, while the measured voltages remain above a specified first threshold (the “No” prong of block 315), load 215 remains engaged. When the measured voltages drop to this first specified threshold (the “Yes” prong of block 315), load 215 is disengaged via switch 220 (block 320). If all discharge cycles have not been completed (the “No” prong of block 325), a pause is provided to allow fuel cell voltages to equalize (block 330) before load 215 is reengaged (block 310). When the monitored fuel cell voltages indicate all discharge cycles have been completed (the “Yes” prong of block 325), N₂ flow across the anode is halted (if it is still active), load 215 is engaged and O₂/air flow is initiated across the anode (while maintaining O₂/air flow across the cathode) until all monitored fuel cell voltage's are below another specified threshold. At this point, fuel cell system 200 has been prepared for shutdown and all O₂/air flow and further monitoring may be terminated (block 335).

In one embodiment, a cycle is considered completed when any monitored (typically minimum) fuel cell's voltage drops to a specified value. Illustrative specified values include 0, 5, 10, 20, 50 and 75 millivolts (“mv”). In like manner, all discharge cycles may be considered complete when any monitored (typically minimum) fuel cell's voltage reaches a specified lower-limit value (e.g., 0, 5, 30, 50 or 75 mv) and the maximum monitored fuel cell's voltage is at or below a specified upper-limit voltage (e.g., 100, 150 or 200 mv). In another embodiment, the total stack voltage is monitored to determine when all hydrogen has been consumed (e.g., when the total stack voltage falls to a specified level or voltage—although it will be understood that it is presently important to ensure that no monitored cell's voltage drops below typically, zero mv). In accordance with the acts of block 335, air flow is then initiated to the anode (recall, air flow is already provided to the cathode) with load 215 engaged until all monitored fuel cell voltages' drop to yet another threshold (e.g., 10, 25, 50 or 75 mv). While the values provided here are illustrative, one of ordinary skill in the art will recognize that the precise values applicable to any given implementation will be dependent on a number of design factors such as, for example, the number of fuel cells in fuel cell stack 205, the type of electrode used, the type of fuel and oxidant employed, the electrical resistance provided by load 215 and the age, age distribution and homogeneity of the fuel cells in fuel cell stack 205.

By way of example only, in a fuel cell system employing H₂ fuel, O₂/air oxidant, a 220 cell fuel cell stack, PEM electrode assemblies and a 10 ohm (“Q”) load, a cycle is considered complete whenever any single monitored fuel cell's voltage drops to 0 mv. All discharge cycles are considered complete when any single monitored fuel cell's voltage drops to 25 mv and the maximum voltage measured at any monitored fuel cell is 200 mv. Following detection of this “all discharge cycles complete” condition, the load is engaged and air flow is initiated to both the anode and cathode until all monitored fuel cells register a voltage of 50 mv or less. Beginning with a substantially fully-charged fuel cell stack, an inter-cycle pause of between 1 to 2 seconds is typical. Start to finish, the described shutdown operation on the system identified here takes approximately 300 seconds, with load 215 engaged for about 60 seconds of this time over approximately 100 cycles.

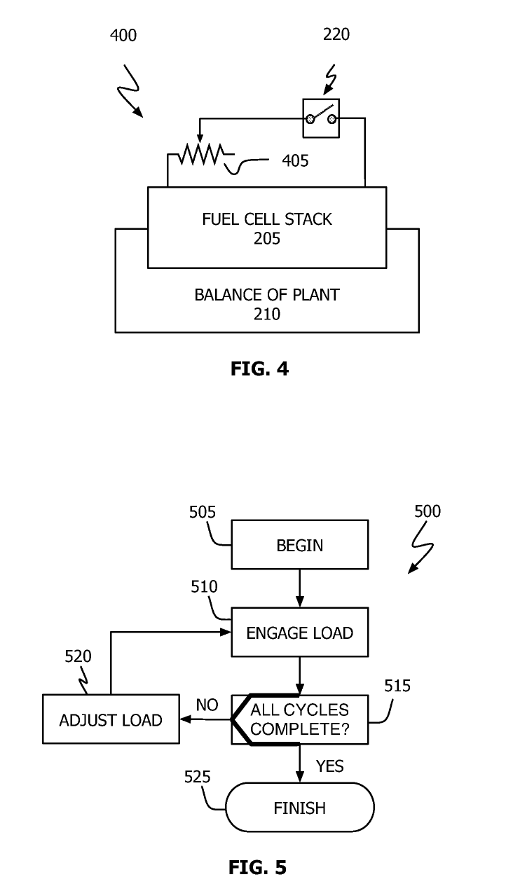

Referring to FIGS. 4 and 5, in another embodiment fuel cell system 400 utilizing variable load 405 may be shutdown in accordance with procedure 500. In this approach, variable load 405 is continuously engaged and periodically adjusted so as to reduce the monitored fuel cell voltages' to a specified shutdown value. Referring again to FIG. 5, in this approach fuel flow is terminated and a purge using N₂ or some other inert gas is initiated across the anode (block 505). Next, and while O₂/air flow across the cathode is maintained, switch 220 is closed to engage variable load 405 (block 510). As before, load 405 may be engaged before, simultaneously with or following the initiation of N₂ purge operations. Initially, variable load 405 is set to a relatively high value so that little current flow is extracted from fuel cell stack 205. In general, load 405 would initially be set to a relatively low value and slowly increased with time based on keeping the minimum monitored cell's voltage above a specified lower threshold (e.g., 0, 5, 30, 50 or 75 mv). While the fuel cells have not been depleted of residual fuel (the “No” prong of block 515), load 405 may be periodically adjusted (block 520). When the measured fuel cell voltages drop to a first specified threshold (the “Yes” prong of block 515), the N₂ purge is terminated and air flow across the anode is initiated. When the monitored fuel cell voltages are at a second threshold, load 405 is disengaged via switch 220 and air flow to both the anode and cathode is terminated (block 525)—completing shutdown operation 500.

In still another embodiment, applicable to both of the above described operations, anode fluid (e.g., N₂ or another inert gas) may be recirculated so as to pass the same fluid over the anode multiple times. Doing this tends to keep fuel cell voltages more constant and as a result, the load (e.g., 215 and 405) may be left engaged for longer periods of time—all other factors remaining the same. In yet another embodiment, maximum value cell voltages may be ignored. For example, as noted above a minimum fuel cell threshold may be used to determine when a cycle is complete and an average voltage level may be used to determine when the shutdown operation is complete (e.g., block 325 and 515). Implementations of this sort may simplify the process by performing a specified number of cycles. In yet another implementation, loads may be engaged and disengaged for specified amounts of time and for a specified number of cycles.

In some embodiments, a fuel cell operational parameter other than voltage may be used to control the load. In principal, any fuel cell operational parameter indicative of the fuel cell's capacity to produce power may be used. For example, shutdown procedure 300 may use the rate of voltage decline during load engagement or the amount of current drawn from fuel cell stack 205 to determine when each or all discharge cycles are complete. It will be further recognized, shutdown procedure 500 may use similar operational parameter tests during the acts of block 515.

It will be recognized that using materials currently available, it is desirable to maintain monitored fuel cell voltages above zero to minimize carbon corrosion of the fuel cells' electrodes. As different materials become available, this consideration may become less significant. As a result, fuel cell voltages may be allowed to drop closer to zero or even go “negative” before determining that each cycle (e.g., block 315) or all cycles (e.g., 325 and 515) are complete.

Various changes in the materials, components, circuit elements, as well as in the details of the illustrated operational methods are possible without departing from the scope of the following claims. For instance, the illustrative systems of FIGS. 2 and 4 are not limited to hydrogen fueled, air oxidized fuel cell systems. In addition, switch 220 may be of any type practical—e.g., electromechanical or electronic. Further, the embodiments of FIGS. 3 and 5 are illustrative only. For example, aspects of both shutdown operations 300 and 500 may be combined; a load may be periodically engaged and disengaged during one epoch and continuously engaged during a second epoch of the shutdown operation—either approach may be used first. In addition, acts in accordance with FIGS. 3 and 5 may be performed by a programmable control device executing instructions organized into one or more program modules. Further, the systems of FIGS. 2 and 4 and the processes of FIGS. 3 and 5 are applicable to sealed anode and/or cathode systems. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

1. A fuel cell system shutdown method, comprising:
halting fuel flow to a plurality of fuel cells, each fuel cell having an anode and a cathode;
flowing an inert gas over the anodes and an oxidizer gas over the cathodes;
engaging a load across the fuel cells;
disengaging the load when a first operational parameter of the fuel cells meets a first criteria;
repeatedly engaging and disengaging the load across the fuel cells until a second operational parameter of the fuel cells meets a second criteria; and
terminating the shutdown when the second operational parameter is detected.

2. The method of claim 1, wherein the inert gas comprises nitrogen.

3. The method of claim 1, wherein the load comprises a fixed resistance.

4. The method of claim 1, wherein the first operational parameter comprises a voltage across each of the fuel cells and the first criteria comprises a specified voltage.

5. The method of claim 4, wherein the specified voltage comprises a voltage greater than, or equal to, zero.

6. The method of claim 1, wherein the first operational parameter comprises a time interval and the first criteria comprises a specified time interval.

7. The method of claim 1, wherein the second operational parameter comprises two specified voltages across each of the fuel cells.

8. The method of claim 7, wherein a first of the two specified voltages comprises a lower-voltage limit and the second of the two specified voltages comprises an upper-voltage limit.

9. The method of claim 8, wherein the specified lower-voltage limit comprises a voltage greater than, or equal to, zero.

10. The method of claim 1, wherein the act of disengaging the load when the first operational parameter of the fuel cells meets the first criteria comprises disengaging the load when the first criteria is met for any one of the fuel cells.

11. The method of claim 1, wherein the act of repeatedly engaging and disengaging the load across the fuel cells comprises:
engaging the load across the fuel cells after determining the fuel cells meet a third criteria; and
disengaging the load across the fuel cells after determining any one of the fuel cells meet the first criteria.

12. The method of claim 11, wherein the third criteria comprises a specified voltage level.

13. The method of claim 1, wherein the act of terminating comprises:
engaging the load across the fuel cells;
halting the flow of the inert gas over the anodes of the fuel cells;
flowing the oxidizer gas over the anodes of the fuel cells; and
halting the flow of the oxidizer gas over the anodes and cathodes of the fuel cells when a third operational parameter of the fuel cells meets a third criteria.

14. The method of claim 13, further comprising disengaging the load after halting the flow of the oxidizer gas over the anodes and cathodes of the fuel cells.

15. The method of claim 13, wherein the third operational parameter of the fuel cells comprises a voltage across each of the fuel cells and the third criteria comprises a third specified voltage.

16. The method of claim 15, wherein the third specified voltage limit comprises a voltage greater than, or equal to, zero

17. A fuel cell system shutdown operation, comprising:
halting fuel flow to a plurality of fuel cells, each fuel cell having an anode and a cathode;
flowing an inert gas over the anodes and an oxidizer gas over the cathodes;
engaging a load across the fuel cells;
changing the load across the fuel cells to substantially discharge the fuel cells;
halting the flow of the inert gas over the anodes of the fuel cells;
flowing oxidizer gas over the anodes of the fuel cells; and
halting the flow of the oxidizer gas over the anodes and cathodes of the fuel cells.

18. The method of claim 17, wherein the act of changing the load across the fuel cells to substantially discharge the fuel cells, comprises loading the fuel cells until at least one of the cells has a voltage that meets a first criteria and all other fuel cells of the plurality of fuel cells meets a second criteria.

19. The method of claim 18, wherein the first criteria comprises a low-limit voltage and the second criteria comprises an upper-limit voltage.

20. The method of claim 19, wherein the low-limit voltage comprises a voltage between approximately 0 and 75 millivolts.

21. A program storage device, readable by a programmable control device, comprising instructions stored thereon for causing the programmable control device to perform the method of claim 1.

22. A fuel cell system, comprising:
a first plurality of fuel cells electrically coupled to form a fuel cell body, each fuel cell having an anode and cathode;
a fuel supply system for supplying a fuel gas to a first side of the fuel cell body;
an oxidant supply system for supplying an oxidant gas to a second side of the fuel cell body;
an inert gas supply for supplying an inert gas to the first side of the fuel cell body;
a second plurality of sensors, each sensing an operating characteristic of a fuel cell in the fuel cell body;
a load; and
a controller for performing the method of claim 1.

23. The fuel cell system of claim 22, wherein the second plurality of sensors comprise a sensor for each of the first plurality of fuel cells.

24. The fuel cell system of claim 22, wherein the second plurality of sensors comprise voltage sensors.
